(19) United States
(12) Patent Application Publication
(10) Pub. No.: US 2013/0091935 A1
(43) Pub. Date: Apr. 18, 2013

(54) LIQUID CHROMATOGRAPH AND PUMP UNIT FOR LIQUID CHROMATOGRAPH

(71) Applicant: Daisuke Akieda, Hitachinaka (JP)

(72) Inventor: Daisuke Akieda, Hitachinaka (JP)

(73) Assignee: HITACHI HIGH-TECHNOLOGIES CORPORATION, Tokyo (JP)

(21) Appl. No.: 13/805,337

(22) PCT Filed: Jul. 5, 2011
(86) PCT No.: PCT/JP2011/065327

§ 371 Date: Dec. 18, 2012

(30) Foreign Application Priority Data
Jul. 6, 2010 (JP) 2010-153538

(51) Int. Cl. G01N 30/02

(52) U.S. Cl. CPC G01N 30/02
USPC 73/61.56

(57) ABSTRACT

In a liquid chromatograph and a pump unit for liquid chromatograph whereby a sample is analyzed while changing the mixing ratio of multiple kinds of solvents, mixing of the solvents can be accelerated without adding any novel device such as a mixer. The pump unit for liquid chromatograph has a configuration which comprises cylinders for introducing a multiple kinds of solvents thereinto and plungers that are reciprocated so as to introduce the solvents and discharge the same for sending, wherein a plurality of channels are formed in the cylinders for mixing the solvents.

### TECHNICAL FIELD

The present invention relates to a liquid chromatograph and particularly to a pump unit for liquid chromatograph.

### BACKGROUND ART

A liquid chromatograph is configured to separate each of components from a sample by sending a solvent for conveying the sample by a pump unit and adding the sample to the solvent and then, by passing it through a separation column, to detect the components by a detector so as to create a chromatogram, and to analyze the components of the sample. Moreover, the liquid chromatograph includes those using a liquid feeding system called low-pressure gradient system for mixing multiple kinds of the solvents while changing a mixing ratio of the solvents by an opening/closing valve and sending the same by a pump unit. In this system, in order to improve accuracy of the mixing ratio of the multiple kinds of the solvents, valves of containers for respective solvents are opened one by one in order for sending the solvents. Therefore, concentration of each solvent is high in a pipeline immediately after the container of the solvent and the solvents are not mixed. However, if these multiple kinds of such solvents are not fully mixed when the sample is introduced, separation of the sample in the separation column becomes insufficient, and analysis accuracy is lowered. Therefore, for example, an attempt to accelerate mixing of the multiple kinds of solvents by providing a mixer in the middle of the pipeline is made(for example, see Patent Literature 1). In order to accelerate mixing, the capacity of the mixer needs to be sufficiently large, and the capacity of the pipeline from the solvents to the separation column becomes large. As a result, back pressure increases, and a load of the pump unit rises, and thus, the pump unit needs to be made larger, which leads to a cost increase.

As a pump unit for liquid chromatograph, a pump unit which repeats suction and discharge of the solvents by plungers provided in cylinders being reciprocated so as to continuously send the solvents is known. The solvents to be mixed by the opening/closing valves are arranged alternately with respect to a flow direction and mixed by diffusion in a liquid feeding process, but its mixing performance is not high. Thus, a technique for accelerating mixing in a space between a cylinder wall and the plungers is proposed (see Patent Literature 2, for example).

### CITATION LIST

### Patent Literature

[Patent Literature 1] JP-A-06-324026

[Patent Literature 2] JP-A-2009-121483

### SUMMARY OF THE INVENTION

### Technical Problem

The present invention has an object to provide, in a liquid chromatograph for analyzing a sample while changing a mixing ratio of multiple kinds of solvents represented by a low-pressure gradient system and a pump unit for liquid chromatograph, an apparatus which can accelerate mixing of the multiple kinds of the solvents without adding any novel device such as a mixer.

### Solution to Problem

In order to solve the above problem, an embodiment of the present invention is a pump unit for liquid chromatograph provided with cylinders for introducing multiple kinds of solvents thereinto and plungers that are reciprocated so as to introduce the multiple kinds of the solvents and discharge the same for feeding the liquid, and particularly having a configuration in which a plurality of channels are formed in the cylinders for mixing the multiple kinds of solvents.

### Advantageous Effects of Invention

According to the present invention, in the liquid chromatograph and a pump unit for liquid chromatograph whereby a sample is analyzed while changing the mixing ratio of the multiple kinds of the solvents, represented by the low-pressure gradient system, a device which can accelerate mixing of the multiple kinds of the solvents without adding any novel device such as a mixer can be provided.

Other objects, features and merits of the present invention will be made apparent from the description of an embodiment of the present invention relating to the attached drawings described below.

### BRIEF DESCRIPTION OF DRAWINGS

FIG. 1 is a configuration diagram illustrating an outline of a liquid chromatograph.

FIG. 2 is an explanatory diagram illustrating a state of a flow of multiple kinds of solvents in a pipeline.

FIG. 3 is a sectional diagram illustrating a configuration of a cylinder portion of a pump unit.

FIG. 4 is a sectional diagram illustrating a configuration of the cylinder portion of the pump unit.

FIG. 5 is a sectional diagram illustrating a configuration of the cylinder portion of the pump unit.

FIG. 6 is a configuration diagram illustrating an outline of a configuration of the pump unit.

### DESCRIPTION OF EMBODIMENTS

An embodiment of the present invention will be described below by referring to the attached drawings.

The above description was made on the embodiment, but the present invention is not limited by that but it is obvious to those skilled in the art that the present invention is capable of various changes and modifications within a range of the spirit of the present invention and the appended claims.

### Embodiment

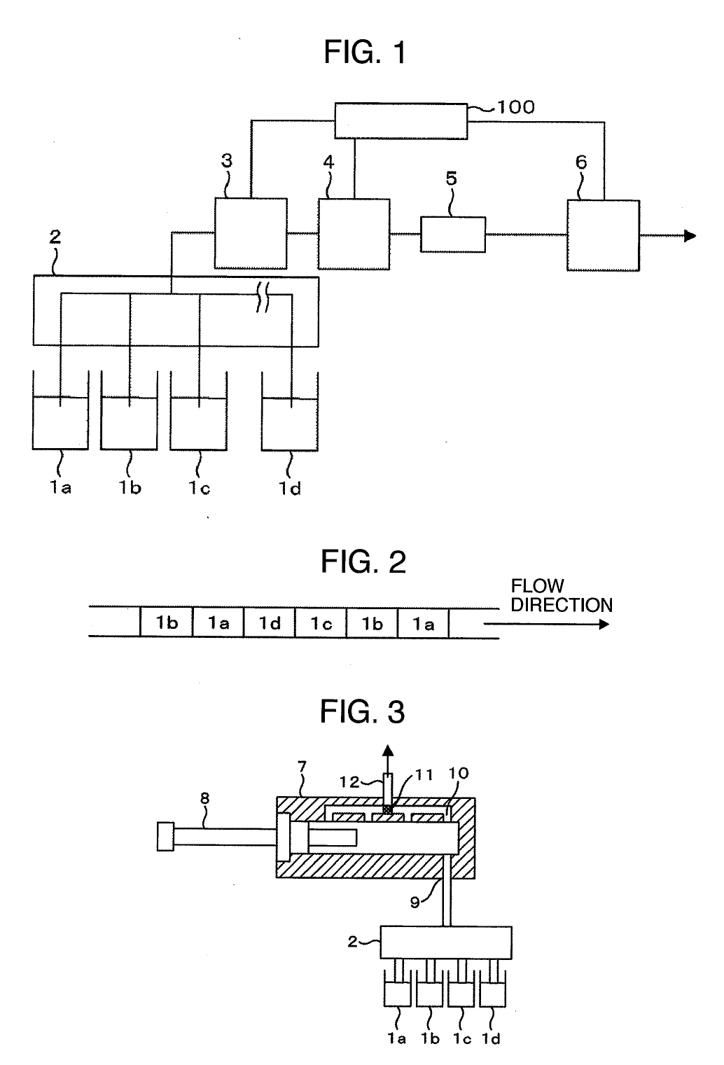

FIG. 1 is a configuration diagram illustrating an outline of a liquid chromatograph and particularly illustrates a typical configuration example of a low-pressure gradient system. The low-pressure gradient system is provided with a solvent switching device 2 for changing a mixing ratio of multiple kinds of solvents stored in a plurality of solvent containers 1a, 1b, 1c, and 1d, respectively, a pump unit 3 such as a plunger pump for sending a solvent, a sample pouring device 4 for pouring a sample to be measured into the solvent, a separation column 5 for separating the sample fed with the solvent, a detector 6 for detecting the separated samples in order, and a controller 100 which controls a switching operation of the solvent switching device 2, switching of a valve of the solvent switching device 2, a discharge capacity of the pump unit 3, and a sample pouring timing of the sample pouring device 4, analyzes data transmitted from the detector 6, and displays a chromatogram on a display, not shown.

FIG. 2 is an explanatory diagram illustrating a state of a flow of the multiple kinds of solvents in a pipeline. In the pipeline between the solvent switching device 2 and the pump unit 3, the four kinds of the solvents illustrated in FIG. 1 flow in clusters, respectively, in the order illustrated in FIG. 2 in accordance with the switching order of the solvent switching device 2.

FIG. 3 is a sectional diagram illustrating a configuration of a cylinder portion of the pump unit and also illustrates a connected state of the solvent containers and the solvent switching device. A plunger 8 is reciprocated by means of motor driving or the like in a cylinder 7 of the pump unit, and the solvent suctioned from an inlet-side channel 9 is discharged from an outlet-side channel 10 by a valve mechanism, not shown, provided in each of the inlet-side channel 9 and the outlet-side channel 10. The controller 100 performs switching of the solvent by the solvent switching device 2 illustrated in FIG. 2 for all the kinds of the solvents when the plunger 8 is in a suctioning process. Then, in a discharging process, all the kinds of the solvents are discharged from the outlet-side channel 10 having a plurality of opening portions, joined together at a filter 11 provided at a confluent portion and fed. By means of this configuration, when the solvent is discharged from the pump unit 3, the multiple kinds of the solvents are in the mixed state.

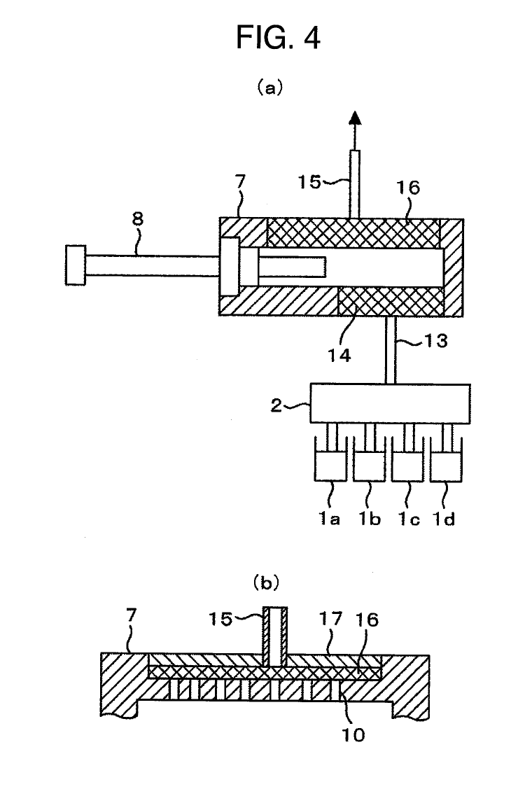

FIG. 4(a) is a configuration in which a filter 14 is provided between an internal space of the cylinder 7 and an inlet-side channel 13, and a filter 16 is provided between the internal space of the cylinder 7 and an outlet-side pipeline 15. Considering a withstanding pressure of the cylinder 7, the filter has a structure as illustrated in FIG. 4(b) in which a plurality of outlet-side channels 10 are formed in the cylinder 7, a channel connecting these channels is formed, the filter 16 is provided in the channel, and a cover 17 for sealing the channel to which the outlet-side pipeline 15 is connected is provided. The inlet-side channel also has a structure in which the filter is provided on the front side of the plurality of channels formed in the cylinder 7. Switching of the solvents by the solvent switching device 2 illustrated in FIG. 2 is performed for all the kinds of the solvents when the plunger 8 is in the suctioning process. The solvents are suctioned into the cylinder 7 while being mixed by the filter 14. Then, in the discharging process, as illustrated in FIG. 4, the solvents pass the plurality of channels and the filter 16 to be mixed and all the kinds of the solvents are discharged from the outlet-side pipeline 15. By means of this configuration, when the solvents are discharged from the pump unit 3, the multiple kinds of the solvents are in the mixed state.

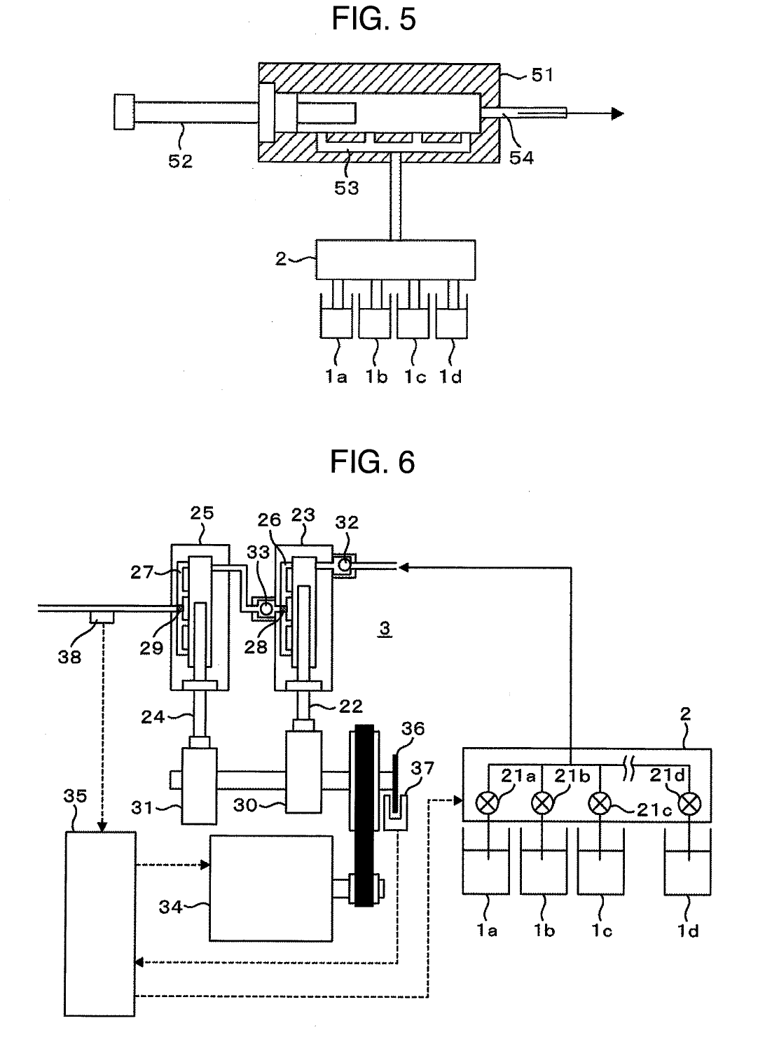

FIG. 5 is a sectional diagram illustrating a configuration of the cylinder portion of the pump unit, and unlike the configuration in FIG. 3, an example of the configuration in which a plurality of channels are formed on the side where the solvents are introduced into the cylinders is illustrated. During a suctioning operation of a plunger 52, the switching valve of the solvent switching device 2 is opened/closed, and the multiple kinds of the solvents in the solvent containers 1a, 1b, 1c, and 1d are suctioned in the order. When the solvents are introduced into a cylinder 51 to pass a plurality of the inlet-side channels 53, the solvents are mixed in the radial direction of the cylinders in the cylinder 51 and discharged from a discharge channel 54 during a discharging operation of the plunger 52.

FIG. 6 is a configuration diagram illustrating an outline of a configuration of the pump unit. This is a pump unit for low-pressure gradient system in which a plurality of cylinders, for example, two cylinders, in each of which an outlet-side channel for mixing the solvents illustrated in FIG. 3 is formed, are provided so that the flow direction of the solvents becomes serial. In the low-pressure gradient system, a chromatogram is created while a mixing ratio of multiple kinds of the solvents determined in advance is time-varied. It is required that the multiple kinds of the solvents are well and equally mixed at a given moment.

The pump unit illustrated in FIG. 6 is provided with a first cylinder 23 in which a first plunger 22 is provided and a second cylinder 25 in which a second plunger 24 is provided. In the first cylinder 23 and the second cylinder 25, a plurality of discharge channels 26 and 27 and confluent portions 28 and 29 where the solvents discharged from each of the discharge channels join together are provided, respectively. In the first cylinder 23, an inlet-side check valve 32 and an outlet-side check valve 33 are provided.

Rotation of a motor 34 is transmitted to a first cam 30 and a second cam 31 to rotate them, and the first plunger 22 and the second plunger 24 are reciprocated by the first cam 30 and the second cam 31, respectively. The rotation of the motor 34 is controlled by a controller 35. On a rotating shaft of the first cam 30 and the second cam 31, a member 36 provided with a slit is attached in order to determine a position of the cam, the slit in the member 36 is detected by a rotation sensor 37, this data is sent to the controller 35, and the positions of the respective cams are determined by the controller 35.

The controller 35 controls the rotation of the motor 34 on the basis of the cam positions and pressure data sent from a pressure detector 38 in the discharge-side channel for measuring a discharge pressure from the second cylinder 25. Moreover, the controller 35 controls opening/closing of switching valves 21a, 21b, 21c, and 21d of the solvent switching device 2 so that a mixing ratio of the solvents required as the low-pressure gradient system is achieved. For these operations, an instruction is sent to each device by reading a program from a memory, not shown, and executing the program by a processor, not shown. In the pipeline between the solvent switching device 2 and the pump unit 3, each solvent flows in the order of opening/closing of the switching valve with respect to the flow direction.

At the start point of sending the solvents, the inlet-side check valve 32 provided on the first cylinder 23 is opened by the controller 35, and the first plunger 22 starts the suctioning operation. Each solvent is introduced through the inlet-side check valve 32 in the order of switching by the solvent switching device 2. When the first cylinder 23 is filled with the solvents, the first plunger 22 stops, and pushing-in in the opposite direction starts. During the pushing-in by the first plunger 22, the inlet-side check valve 32 is closed, the outlet-side check valve 33 is opened, and the solvents in the first cylinder 23 are introduced into the second cylinder 25. A plurality of the discharge channels 26 as illustrated in FIG. 3 are formed in the first cylinder 23, and the solvents join together with each other at the confluent portion 28 and flow to the outlet-side check valve 33. The plurality of solvents in the first cylinder 23 are mixed together during the suctioning operation of the first plunger 22 and joining in the confluent portion 28 after flowing through the plurality of discharge channels 26. When the suctioning operation of the second plunger 24 is finished, and the pushing-in in the opposite direction starts, the outlet-side check valve 33 is closed, and the solvents in the second cylinder 25 flow through the plurality of discharge channels 27 provided in the second cylinder 25 as illustrated in FIG. 3, and pass through the confluent portion 29 to be further mixed together.

In this embodiment, the example in which the plurality of discharge channels illustrated in FIG. 3 are provided in two cylinders is described, but it may be so configured that a filter is provided in the confluent portion or a cylinder having a structure in which mixing is performed by the filter illustrated in FIG. 4 can be used for mixing the solvents. Moreover, by using the cylinders having a structure in which a plurality of channels are provided on the inlet side as illustrated in FIG. 5, the solvents can also be mixed. Moreover, in the pump unit for liquid chromatograph configured such that the two cylinders are arranged so that the flow directions of the solvents become parallel, the mixing of the solvents can also be accelerated by employing the configurations illustrated in FIGS. 3, 4, and 5.

As described above, according to the embodiment of the present invention, in the liquid chromatograph and a pump unit for liquid chromatograph whereby a sample is analyzed while changing the mixing ratio of multiple kinds of solvents, represented by a low-pressure gradient system, an apparatus which can accelerate mixing of the multiple kinds of the solvents can be provided without adding any novel device such as a mixer.

### REFERENCE SIGNS LIST

2 solvent switching device

3 pump unit

7, 51 cylinder

8, 52 plunger

9, 13 inlet-side channel

10 outlet-side channel

11, 14, 16 filter

12, 15 outlet-side pipeline

17 cover

22 first plunger

23 first cylinder

24 second plunger

25 second cylinder

32 inlet-side check valve

33 outlet-side check valve

53 inlet-side channels

54 discharge channel

1. A liquid chromatograph for introducing a sample while changing a mixing ratio of multiple kinds of solvents, and separating the sample by a separation column to detect components, comprising:
a pump unit configured to send the multiple kinds of the solvents to the separation column, wherein
said pump unit has cylinders into which said multiple kinds of the solvents are introduced, plungers that are reciprocated so as to introduce said multiple kinds of the solvents and discharge the same for sending, and a plurality of channels in which said multiple kinds of the solvents are mixed.

2. The liquid chromatograph according to claim 1, wherein
said plurality of channels are provided on a side where said multiple kinds of the solvents are discharged from said cylinders.

3. The liquid chromatograph according to claim 2, wherein
a confluent portion is provided on rear stream sides of said plurality of channels.

4. The liquid chromatograph according to claim 2, wherein
a filter is provided on rear stream sides of said plurality of channels.

5. The liquid chromatograph according to claim 1, wherein
said plurality of channels are provided on a side where said multiple kinds of the solvents are introduced into said cylinders.

6. The liquid chromatograph according to claim 5, wherein
a filter is provided on front sides of said plurality of channels.

7. A pump unit for liquid chromatograph, the pump unit configured to send multiple kinds of solvents to a separation column and comprising:
cylinders into which said multiple kinds of the solvents are introduced, plungers that are reciprocated so as to introduce said multiple kinds of the solvents and discharge the same for sending, and a plurality of channels in which said multiple kinds of the solvents are mixed.

8. The pump unit for liquid chromatograph according to claim 7, wherein
said plurality of channels are provided on a side where said multiple kinds of the solvents are discharged from said cylinders.

9. The pump unit for liquid chromatograph according to claim 8, wherein
a confluent portion is provided on rear stream sides of said plurality of channels.

10. The pump unit for liquid chromatograph according to claim 8, wherein
a filter is provided on rear stream sides of said plurality of channels.

11. The pump unit for liquid chromatograph according to claim 7, wherein
said plurality of channels are provided on a side where said multiple kinds of the solvents are introduced into said cylinders.

12. The pump unit for liquid chromatograph according to claim 11, wherein
a filter is provided on front sides of said plurality of channels.
